(19) United States
(12) Patent Application Publication
(10) Pub. No.: US 2003/0013331 A1
(43) Pub. Date: Jan. 16, 2003

(54) Reduced dimension male electric plug

(76) Inventors: Thomas K. Reusche, Elburn, IL (US); Donald B. Owen, Batavia, IL (US)

Correspondence Address: Kirk A. Vander Leest, McAndrews, Held & Malloy, Ltd., Suite 3400, 500 West Madison, Chicago, IL, 60661, US

(21) Appl. No.: 10/192,332

(22) Filed: Jul. 10, 2002

Related U.S. Application Data
(60) Provisional application No. 60/304,832, filed on Jul. 12, 2001.
(60) Provisional application No. 60/306,224, filed on Jul. 18, 2001.
(60) Provisional application No. 60/354,784, filed on Feb. 5, 2002.

(51) Int. Cl. H01R 4/66

(52) U.S. Cl. 439/106

(57) ABSTRACT

According to certain aspects of an embodiment of the present invention, a male electrical plug has housing supporting a line blade and neutral blade and a grounding pin which are oriented for insertion into a conventional electrical outlet. The housing is sized to permit it to be inserted through drain plug openings that are less than 1 inch in diameter. In one embodiment, the housing of the plug is formed such that the wall thickness around the line and neutral blades is as thin as 3/32 of an inch and the wall thickness around the ground pin is less than 3/32 of an inch. In one embodiment the wall thickness around the ground pin on the order of 1/16 of an inch. The ground pin may be offset inwardly within the housing to provide additional wall thickness around the ground pin, thereby increasing the structural rigidity of the plug. The blades may include reduced sized and/or offset portions that are embedded within the housing and outer portions sized to mate with reciprocal openings in an outlet. The bottom wall of the housing may be radiused to facilitate insertion of the housing through circular openings.

### RELATED APPLICATIONS

This application is related to, and claims priority from Provisional Application No. 60/304,832 filed Jul. 12, 2001 and entitled “Reduced Dimension Male Electric Plug”, Provisional Application No. 60/306,224 filed Jul. 18, 2001 and entitled “Reduced Dimension Male Electric Plug”, and Provisional Application No. 60/354,784 filed Feb. 5, 2002 and entitled “Reduced Dimension Male Electric Plug”. The disclosures of the '832, '224 and '784 provisional applications are hereby incorporated herein by reference in their entirety.

### BACKGROUND OF THE INVENTION

This invention relates generally to electrical plugs, and, more particularly, to an electrical plug having a reduced outer cross-sectional dimension. The plug is particularly well-suited for use with drain plug heater (deicers) for livestock water tanks. Heaters for livestock water tanks are often designed that the power cord can be routed through the drain plug opening in the water tank. Among other things, such a design prevents the heater from being dislodged from the tank by animals that use the tank. However, the size of the drain plug opening varies depending on the tank manufacturer, and in many instances the drain openings are too small to permit a standard male plug of the power cord to be inserted through the opening. In response to this problem, U.S. Pat. No. 6,151,448 discloses the use of “split” cord construction. However, this split cord construction requires the use of extra components, and, hence, it is relatively expensive to manufacture. Additionally, if the detachable section of the power cord is damaged or misplaced the heater will be rendering inoperable. As a result, there is a need for an electrical plug which can be passed through drain plug openings of less than 1 inch in diameter.

### BRIEF SUMMARY OF INVENTION

According to certain aspects of an embodiment of the present invention, a male electrical plug has housing supporting a line blade, a neutral blade and a grounding pin which are oriented for insertion into a conventional electrical outlet. The housing is sized to permit it to be inserted through drain plug openings that are less than 1 inch in diameter. In one embodiment, the housing of the plug is formed such that the wall thickness around the line and neutral blades is as thin as 3/32 of an inch and the wall thickness around the ground pin is less than 3/32 of an inch. In one embodiment the wall thickness around the ground pin on the order of 1/16 of an inch. The ground pin may be offset inwardly within the housing to provide additional wall thickness around the ground pin, thereby increasing the structural rigidity of the plug. The blades may include reduced sized portions that are embedded within the housing and outer portions sized to mate with reciprocal openings in an outlet.

### BRIEF DESCRIPTION OF SEVERAL VIEWS OF THE DRAWINGS

FIG. 1 is a perspective view of an electrical plug in accordance with certain aspects of the present invention.

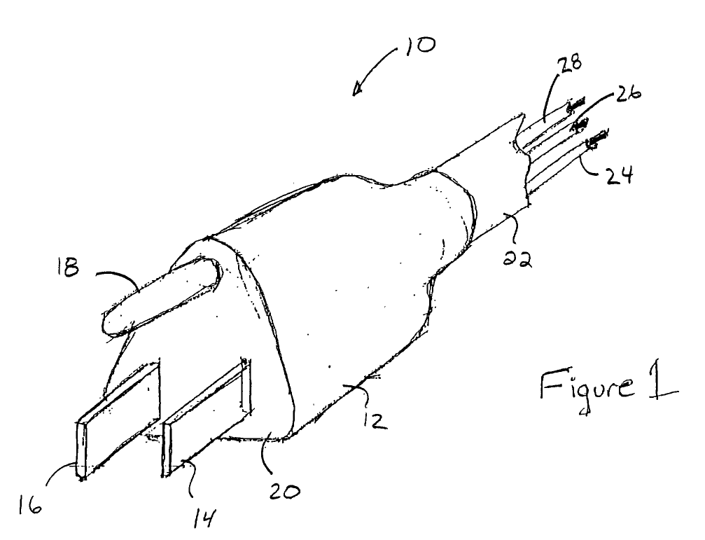

FIGS. 2A and 2B are end views of a first embodiment of the electrical plug.

FIG. 3 is a cross-sectional view of an alternative embodiment of the electrical plug, wherein the ground pin is offset inwardly within the housing to provide additional wall thickness around the ground pin, thereby increasing the structural rigidity of the plug.

FIG. 4 is a cross-sectional view of another alternative embodiment of the electrical plug, wherein the blades include reduced dimension inner portions.

FIGS. 5-8 illustrate another embodiment of an electrical plug according to certain aspects of the present invention.

### DETAILED DESCRIPTION OF THE PREFERRED EMBODIMENT OF THE INVENTION

Referring now to the drawings, an electric plug 10 in accordance with certain aspects of a first embodiment of the present invention includes a housing (or body) 12 which supports a line blade 14, a neutral blade 16, and a ground pin 18. The blades 14, 16 and the ground pin 18 extend from a face 20 of the housing 12 and are oriented for insertion into a conventional electrical outlet (not shown). As will be appreciated, the plug 10 may be a polarized plug, in which case the neutral blade 16 has an increased height in comparison to the line blade 14. A power cord 22 extends from the rear of the plug 10 with the sheath of the power cord being encapsulated within the housing 12 of the plug. Within the plug's housing 12, the sheath has been removed to allow the wires from the power cord 22 to be separated for interconnection with the appropriate conductive prongs. In particular, the line wire 24 is electrically and mechanically interconnected with the line blade 14, the neutral wire 26 is electrically and mechanically interconnected with the neutral blade 16, and the ground wire 28 is electrically and mechanically interconnected with the ground pin 18. The other end of the power cord 22 may, for example, be connected to a livestock tank heater of the type described in U.S. Pat. No. 6,151,448 to Reusche et al. and entitled “Electric Heater For A Livestock Water Tank,” the disclosure of which is hereby incorporated by reference. When the plug 10 is used in connection with a livestock tank heater, it is desirable to provide a drain plug adapter which mounts around the power cord and which is configured for installation through the drain plug opening to seal the drain plug opening against water leakage therethrough. Suitable drain plug adapters are disclosed in the aforementioned U.S. Pat. No. 6,151,448 and also in U.S. Pat. No. 6,353,708, which issued on Mar. 5, 2002 and is entitled “Apparatus For Mounting An Electrical Heater Through A Water Tank Drain Plug Opening.” The disclosure of the '708 patent is hereby incorporated by reference. It will be appreciated, however, that the plug 10 has applications beyond use with a livestock tank heater, and that the plug 10 may be used in any application where it is desirable to minimize the cross-sectional dimension of an electrical plug.

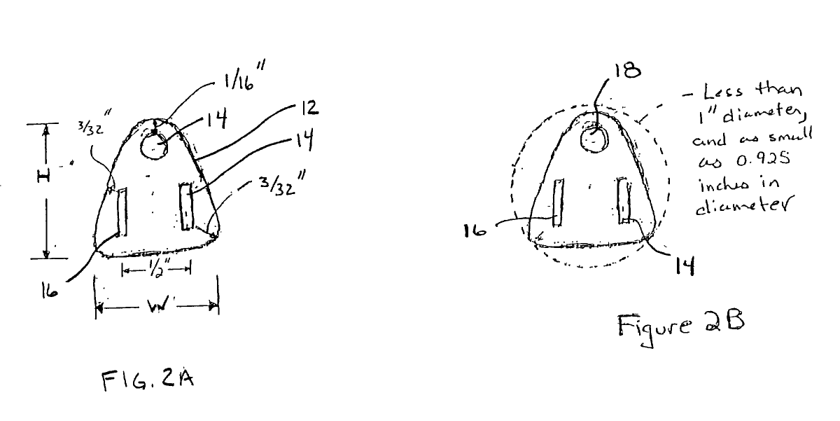

Referring now to FIGS. 2A and 2B, the housing 12 is constructed such that the wall thickness around the line and neutral blades and the ground pin is minimized to reduce the outer cross-sectional dimension of the plug. In the illustrated embodiment, the wall thickness around the live and neutral blades can be as thin as 3/32 of an inch, while the wall thickness around the ground pin is preferably less than 3/32 of an inch. In this respect, the wall thickness around the ground pin is preferably between 1/32 of an inch and 3/32 of an inch, and may, as is shown, be on the order of 1/16 of an inch. This allows the plug to have a height H on the order of 0.837 inches and a width W on the order of 11/16 (or 0.6875) inches. The nominal spacing between centers of the line and neutral blades is on the order of 0.50 inches, as is shown. Constructing the plug in this respect allows it to be inserted through openings of less than 1 inch in diameter, and preferably as small as 0.925 inches. The height of the plug can be further reduced by thinning the wall thickness around the ground pin to approximately 1/32 of an inch.

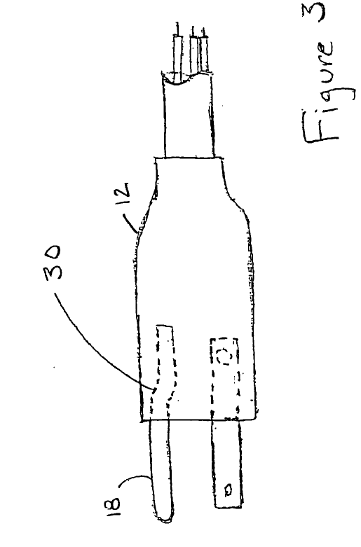

As is shown in FIG. 3, the ground pin 18 may be offset inwardly (as shown at reference number 30) within the housing 12 of the plug 10 to provide additional wall thickness around the ground pin 18, thereby increasing the structural rigidity of the plug. As will be appreciated, the line and neutral blades may also be offset inwardly within the housing.

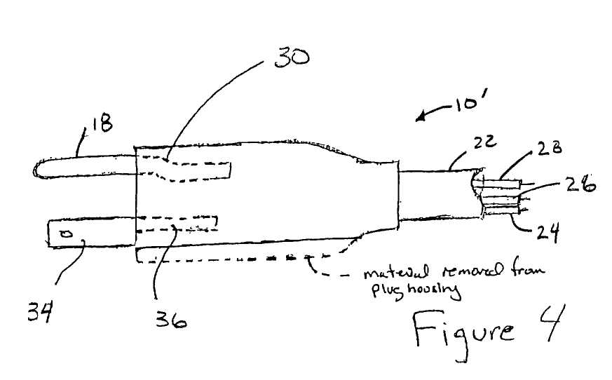

FIG. 4 illustrates certain aspects of an electric plug 10′ according to an alternative embodiment of the present invention. In this embodiment, the line and neutral blades have an outer portion 34 and a reduced dimension inner portion 36. The outer portion 34 is sized to mate with a reciprocal blade receiving aperture of a convention electrical outlet (not shown). The inner portion 36 of the blade is smaller than (and/or inwardly offset from) the outer portion 34 and is encapsulated in the plug's housing 12. This design allows the outer dimension of the housing 12B to be reduced (as is shown by the broken line in FIG. 4) while still providing sufficient wall thickness around the blades 14, 16 to retain the blades in the housing 12. As is shown in FIG. 4, the ground pin 18 may be offset, as was described above in connection with FIG. 4. Alternatively, the ground pin may be constructed with a reduced size internal portion, in a manner similar to the line and neutral blades.

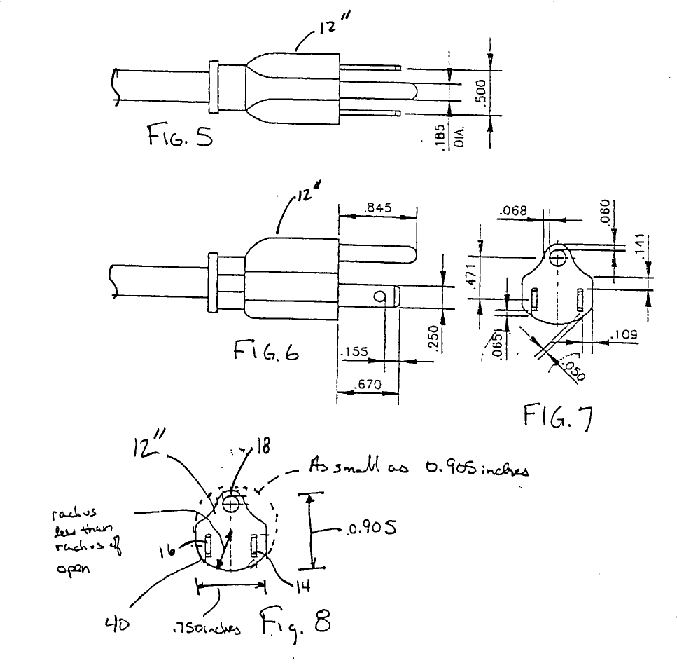

FIGS. 5-7 illustrate certain other aspects according to another embodiment of the present invention. In this embodiment, the housing 12″ has a maximum outer cross-sectional dimension on the order of 0.9 inches, and preferably on the order of 0.905 inches. This allows the plug to be inserted through drain openings having diameters as small as 0.905 inches. The bottom wall 40 of the plug housing is radiused to the same or a smaller radius than the smallest opening for which the plug is designated.

Although the invention has been described with reference to preferred embodiments, workers skilled in the art will recognize that changes may be made in form and detail without departing from the scope and spirit of the invention.

1. A male electrical plug of the type having housing supporting a line blade and neutral blade and a ground pin which are oriented for insertion into a conventional electrical outlet, the improvement comprising forming the housing such that the wall thickness around the line and neutral blades is as thin as 3/32 of an inch and the wall thickness around the ground pin is no greater than 3/32 of an inch.

2. A male electrical plug as set forth in claim 1, wherein the wall thickness of the housing around the ground pin is between 1/32 and 3/32 of an inch.

3. A male electrical plug as set forth in claim 1, wherein the ground pin is offset inwardly within the housing of the plug to provide additional wall thickness around the ground pin, thereby increasing the structural rigidity of the plug.

4. A male electrical plug as set forth in claim 1, wherein the plug is a polarized plug.

5. A male electrical plug having a height on the order of 0.837 inches and a width on the order of 0.6875 inches.

6. A male electrical plug sized for insertion through openings as small as 0.905 inches in diameter.

7. A male electrical plug sized for insertion through openings having diameters of less than 1.0 inches.

8. A male electrical plug of the type having a housing and a grounding pin supported in the housing, wherein the ground pin is offset inwardly within housing of the plug.

9. A livestock water tank heater comprising:
an electrical heating element;
a male plug adapted for connection to a conventional electrical outlet for insertion through drain plug openings as small as 0.925 inches in diameter; and
a power cord extending between the electrical heating element and the male plug.

10. A male electrical plug having a maximum outer cross-section dimension of approximately 0.905 inches.

11. A male electrical plug comprising
a housing;
a ground pin supported by the housing;
a line blade supported by the housing;
a neutral blade supported by the housing;
at least one of the ground pin, the line blade and the neutral blade being offset inwardly within the housing to allow an outer dimension of the housing to be of a reduced size.

12. A male electrical plug, comprising:
a line blade supported by the housing;
a neutral blade supported by the housing; and
wherein the line and neutral blades have reduced sized inner portions to allow an outer dimension of the housing to be reduced.

13. A male electrical plug comprising:
a housing;
a ground pin supported by the housing;
a line blade supported by the housing;
a neutral blade supported by the housing; and
the housing having a bottom wall that is radiused to facilitate insertion of the plug through circular openings.
